(19) United States
(12) Patent Application Publication
(10) Pub. No.: US 2025/0057235 A1
(43) Pub. Date: Feb. 20, 2025

(54) AEROSOL PROVISION DEVICE

(71) Applicant: Nicoventures Trading Limited, London (GB)

(72) Inventors: Jorge GOMEZ, London (GB); Matthew HOLDEN, London (GB); Conor MCGRATH, London (GB)

(21) Appl. No.: 18/723,441

(22) PCT Filed: Dec. 19, 2022
(86) PCT No.: PCT/EP2022/086793

§ 371 Date: Jun. 23, 2024

(30) Foreign Application Priority Data
Dec. 23, 2021 (GB) 2118880.0

(51) Int. Cl. A24F 40/465; A24F 40/20; H05B 6/10

(52) U.S. Cl. CPC A24F 40/465; A24F 40/20; H05B 6/108

(57) ABSTRACT

An aerosol provision device includes a heating assembly arranged to receive at least a portion of an article containing aerosol generating material. The device also has a power supply; a first housing enclosing at least part of the heating assembly and a second housing enclosing at least part of the power supply. A thermal conduction arrangement is provided in thermal contact between the first housing and the second housing to dissipate heat from the first housing to the second housing.

### RELATED APPLICATIONS

The present application is a National Phase entry of PCT Application No. PCT/EP2022/086793 filed Dec. 19, 2022, which claims priority to GB Application No. 2118880.0 filed Dec. 23, 2021, each of which is hereby incorporated by reference in their entirety.

### TECHNICAL FIELD

The present invention relates to an aerosol provision device and an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device comprising: a heating assembly arranged to receive at least a portion of an article containing aerosol generating material; a power supply; a first housing enclosing at least part of the heating assembly; a second housing enclosing at least part of the power supply; and a thermal conduction arrangement in thermal contact between the first housing and the second housing to dissipate heat from the first housing to the second housing.

The thermal conduction arrangement may comprise a conduction member.

The thermal conduction arrangement may comprise at least two conduction members.

The or each conduction member may define a direct conduction path between the first housing and the second housing.

The or each conduction member may be in direct engagement with the first housing.

The first housing may be mounted with the or each conduction member.

The second housing may be mounted with the or each conduction member.

The thermal conduction arrangement may comprise a greater material mass than the first housing.

The aerosol provision device may comprise a chassis. The chassis may be arranged to retain the power supply.

The chassis may be arranged to act as a heat sink.

The chassis may comprise the or each conduction member. The chassis may be at least partially enclosed by the second housing.

The chassis may comprise an insulation member.

The insulation member and the conduction member may be integrally formed.

The insulation member may be formed of Polycarbonate (PC).

The aerosol provision device may comprise an electrical module.

The electrical module may be mounted on the insulation member.

The insulation member may electrically isolate the electrical module from the conduction member.

The first housing may be at least partially tubular.

The heating assembly may be retained between the first housing and the conduction member.

The thermal conduction arrangement may comprise a heat dissipation layer between the second housing and the power supply.

The heat dissipation layer may be on an inner side of the second housing.

The heat dissipation layer may be in thermal contact with the conduction member.

The heat dissipation layer may define a thermal conductive path between the conduction member and the second housing.

The heat dissipation layer may comprise a graphite liner.

In accordance with some embodiments described herein, there is provided an aerosol provision device comprising: a heating assembly arranged to receive at least a portion of an article containing aerosol generating material; a power supply; a first housing enclosing at least part of the heating assembly; a second housing enclosing at least part of the power supply; and a heat dissipation arrangement comprising a graphite liner between the power supply and the second housing.

The heat dissipation layer may be on an inner side of the second housing.

The heat dissipation layer may be in thermal contact with the conduction member.

The heat dissipation layer may define a thermal conductive path between the conduction member and the second housing.

The heat dissipation layer may comprise a graphite liner.

The device as described in any of the above may be a tobacco heating device, also known as a heat-not-burn device.

In accordance with some embodiments described herein, there is provided an aerosol provision system comprising: an aerosol provision device as described in any of the above; and an article comprising aerosol generating material, wherein the article is dimensioned to be at least partially received within the receptacle.

### BRIEF DESCRIPTION OF THE DRAWINGS

Embodiments of the invention will now be described, by way of example only, with reference to accompanying drawings, in which:

FIG. 1 shows a front view of an aerosol provision device;

FIG. 2 shows a perspective side view of the aerosol provision device of FIG. 1;

FIG. 3 shows a cross-sectional side view of an aerosol generator of the aerosol provision device of FIG. 1;

FIG. 4 shows a perspective view of a thermal conduction arrangement of the aerosol provision device of FIG. 1 with a battery in place;

FIG. 5 shows a perspective view of the thermal conduction arrangement of FIG. 4 with the battery omitted;

FIG. 6 shows a perspective view of the heat dissipation arrangement of FIG. 4, including a graphite liner; and

FIG. 7 shows a perspective view of the heat dissipation of FIG. 6, including the second housing and battery.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

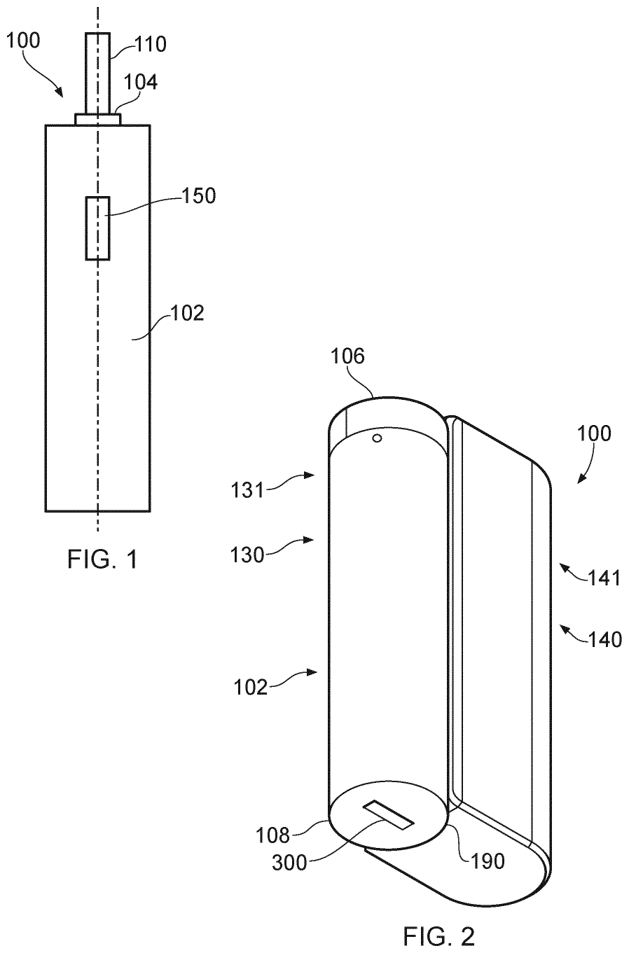

FIG. 1 shows an aerosol provision device 100 for generating aerosol from an aerosol generating material. In broad outline, the device 100 may be used to heat a replaceable article 110 comprising the aerosol generating material, to generate an aerosol or other inhalable medium which is inhaled by a user of the device 100.

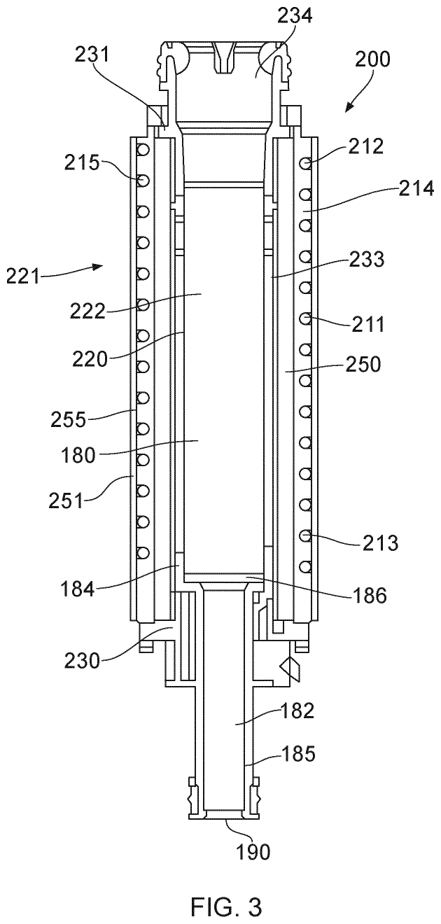

The device 100 comprises a body 102. A housing arrangement surrounds and houses various components of the body 102. An article aperture 104 in formed at one end of the body 102, through which the article 110 may be inserted for heating by an aerosol generator 200 (refer to FIG. 3). In use, the article 110 may be fully or partially inserted into the aerosol generator 200 where it may be heated by one or more components of the aerosol generator 200. The article 110 and the device 100 together form an aerosol provision system 101.

The device 100 may also include a user-operable control element 150, such as a button or switch, which operates the device 100 when pressed. For example, a user may turn on the device 100 by operating the switch 150.

The aerosol generator 200 defines a longitudinal axis.

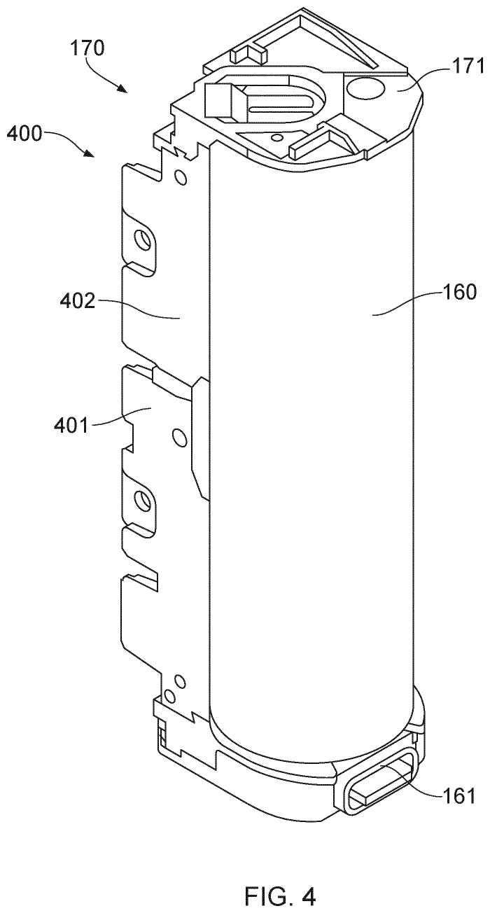

FIG. 2 shows a perspective view of the device 100. The device 100 comprises a first body assembly 130 and a second body assembly 140. The first body assembly 130 comprises the aerosol generator 200. Referring to FIG. 4, the second body assembly 140 comprises a power source 160 and at least one electronics module such as an electrical connector 161. A chassis 170 supports the power source 160 and other components.

The first body assembly 130 comprises a first housing 131. The second body assembly 140 comprises a second housing 141. The first and second body assemblies 130, 140 are fixedly mounted. The first and second body assemblies 130, 140 form the body 102.

The body 102 has end surfaces of the device 100. The end of the device 100 closest to the article aperture 104 may be known as the proximal end (or mouth end) 106 of the device 100 because, in use, it is closest to the mouth of the user. In use, a user inserts an article 110 into the aperture 104, operates the aerosol generator 200 to begin heating the aerosol generating material and draws on the aerosol generated in the device. This causes the aerosol to flow through the device 100 along a flow path towards the proximal end of the device 100.

The other end of the device furthest away from the aperture 104 may be known as the distal end 108 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

As used herein, one-piece component refers to a component of the device 100 which is not separable into two or more components following assembly of the device 100. Integrally formed relates to two or more features that are formed into a one-piece component during a manufacturing stage of the component.

Referring to FIGS. 2 and 3, an air flow passage 180 extends through the body 102. The airflow passage 180 extends to an opening 190. The opening 190 acts as an air inlet. An outer cover 300 covers the opening 190. The outer cover 300 in embodiments is vented to allow the flow of air into the air flow passage 180.

The power source 160 is disposed in the second housing 141. The chassis 170 mounts the power source 160. The chassis 170 comprises a power supply mount 171. The chassis 170 partially encloses the power source 160. The power source 160 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 200 to supply electrical power when required and under control of a controller to heat the aerosol generating material.

The electronics module 161 may comprise, for example, a printed circuit board (PCB). The PCB may support at least one controller, such as a processor, and memory. The PCB may also comprise one or more electrical tracks to electrically connect together various electronic components of the device 100. For example, the battery terminals may be electrically connected to the PCB so that power can be distributed throughout the device 100.

FIG. 3 shows a cross-sectional view of the aerosol generator 200. In one example, the aerosol generator 200 comprises an induction-type heating system, including a magnetic field generator 210. The magnetic field generator 210 comprises an inductor coil assembly 211. The aerosol generator 200 comprises a heating element 220. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 200 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly 211 includes a first inductor coil 212 and a second inductor coil 213. In embodiments, the number of inductor coils 212, 213 differs. In embodiments, a single inductor coil is used. The inductor coil assembly 211 also comprises a coil support 214. The coil support 214 is tubular. The coil support 214 comprises a guide 215 for the coils 212, 213. The guide 215 comprises a channel on an outer side of the coil support 214.

The heating element 220 is part of a heating assembly 221. The heating element 220 of this example is hollow and therefore defines at least part of a receptacle 222 within which aerosol generating material is received. For example, the article 110 can be inserted into the heating element 220. The heating element 220 is tubular, with a circular cross section. The heating element 220 has a generally constant diameter along its axial length.

The heating element 220 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element 220 may not be limited to being inductively heated. The feature, acting as a heating element, may therefore be heatable by electrical resistance. The aerosol generator 200 may therefore comprise electrical contacts for electrical connection with the apparatus for electrically activating the heating element by passing a flow of electrical energy through the heating element.

The receptacle 222 and article 110 are dimensioned so that the article 110 is received by the heating element 220. This helps ensure that the heating is most efficient. The article 110 of this example comprises aerosol generating material. The aerosol generating material is positioned within the receptacle 222. The article 110 may also comprise other components such as a filter, wrapping materials and/or a cooling structure.

A first end support 230 supports the heating element 220. The first end support 230 supports the heating element 220 at a first, distal, end. A second end support 231 supports the heating element 220. The second end support 231 supports the heating element 220 at a second, proximal, end. The first and second end supports 230, 231 act as receptacle supports.

The air flow passage 180 extends from the heating element 220. The air flow passage 180 extending from the heating element 220 is defined by a flow path member 182. The heating element 220 and the flow path member 182 forms part of an airflow path arrangement.

The flow path member 182 extends between the heating element 220 and the opening 190. The flow path member 182 is tubular. The flow path member 182 defines a bore. The flow path member extends in an axial direction along its length.

The flow path member 182 and the heating element 220 intersect at a juncture. The flow path member 182 overlaps the heating element 220. The flow path member 182 comprises a first section 184 having a first diameter and a second section 185 having a second diameter. The diameter of the first section 184 is greater than the diameter of the second section 185. An intermediate section 186 extends between the first and second sections 184, 185. The intermediate section 186 forms a shoulder. The shoulder acts as a stop to limit insertion of the article 110.

The fluid seal at the juncture 183 is formed in embodiments by a mechanical fabricated joint, for example a weld.

The first end support 230 supports the flow path member 182. The first end support 230 forms a collar. In embodiments in which the flow path member 182 is omitted, the first end support 230 engages the heating element 220 directly. The first end support 230 extends away from the first end of the heating element 220 towards the distal end of the device 100.

The second end support 231 defines an insertion chamber 234. The insertion chamber 234 is configured to receive the article 110 therethrough.

The heating element 220 extends between the first and second end supports 230, 231. A barrier member 233 extends between the first end support 230 and the second end support 231. The barrier member 233 together with the first and second end supports 230, 231 encloses the heating element 220. The barrier member 233 is a hollow, tubular member.

In embodiments, the barrier member 233 is formed from a non-metallic material to assist with limiting interference with magnetic induction. In this particular example, the barrier member 233 is constructed from polyether ether ketone (PEEK). The first and second end supports 230, 231 are constructed from PEEK. Other suitable materials are possible. Parts formed from such materials help ensure that the barrier member 250 remains rigid/solid when the susceptor is heated.

The heating element 220, the barrier member 233, and the first and second end supports 230, 231 are coaxial around the central longitudinal axis of the heating element 220.

The first end support 230 fluidly seals with the airflow path arrangement 181. The second end support 231 fluidly seals with the airflow path arrangement 181. In embodiments, the first end support 230 fluidly seals with the heating element 220. In embodiments, the first end support fluidly seals with the flow path member 182. The second end support 231 fluidly seals with the heating element 220.

The first and second end supports 230, 231 support the coil support 214. An insulation layer 250 is disposed between the barrier member 233 and the coil support 214. A ferrite shield 255 extends around the inductor coils 212, 213. The ferrite shield acts as an electromagnetic shield. Other suitable materials may be used. The ferrite shield 255 is mounted on the coil support 200. The ferrite shield 255 abuts the coils support 200 and so may be directly mounted to the coil support 200, for example by adhering.

The insulation layer 250 acts as an inner insulation layer 250. An outer insulation layer 251 extends around the inductor coil assembly. The outer insulating layer 251 forms a tubular arrangement.

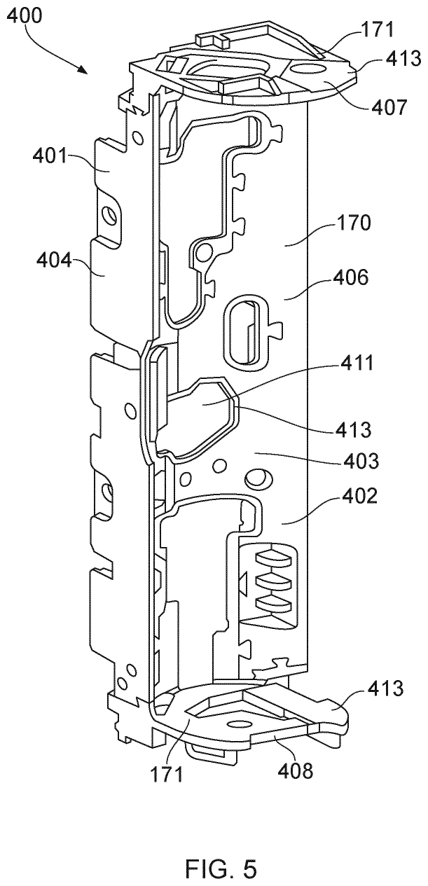

FIG. 4 shows the chassis 170 with the power source 160 (a battery in the illustrated embodiment) mounted on the chassis 170. FIG. 5 shows chassis 170 with the power source 160 omitted. As can be seen from both FIG. 4 and FIG. 5, the chassis 170 comprises a chassis body 402. The chassis body 402 comprises a conduction member 406. The chassis body 402 comprises insulation members 413. The conduction member 406 and the insulation members 413 together form the chassis body 402. The conduction member 406 and the insulation members 413 are integrally formed. The insulation members 413 are formed on the conduction member 406. In this arrangement the conduction member 406 acts as a primary portion, with the insulation members 413 acting as secondary portions on the conduction member 406. In embodiments, the conduction member 406 acts as the secondary portion. In embodiments, the chassis body 402 comprises multiple conduction members. In embodiments, the chassis body 402 comprises a single insulation member. In embodiments, the chassis body 402 comprises a single conduction member. In such embodiments, insulation members may be provided separately.

The insulation members 413 are molded about the conduction member 406. The conduction member 406 is formed from an aluminum alloy. Other suitable materials may be used, such as copper, magnesium, zinc, or brass alloys. The insulation members 413 are formed of PC (Polycarbonate), however it will be understood that any suitable electrically insulating material, such as polymers, may be used.

The chassis body 402 comprises a main section 403. The main section 403 extends longitudinally. The main section 403 comprises a concave surface. The concave surface is arranged to receive part of the power source 160. End portions 407, 408 protrude from the main section 403. The end portions 407 form end plates. A first end portion is at the proximal end and a second end portion is at the distal end. The end portions 407, 408 are formed by insulation members 413.

Flanged sections 404 extend from the main section 403. The flanged sections 404 may differ in number, and in embodiments is a single flanged section 404. The flanged sections 404 define conduction elements of the conduction member 406.

The flanged sections 404 include flat protrusions extending away from the power source 160, and towards the first housing 131. The portions of the conduction member 406 define a thermal conduction arrangement 400.

The chassis 170 comprises mounting arrangements 411. The mounting arrangements 411 comprise, for example, mounting apertures and mounting protrusions. The mounting arrangements 411 are configured to mount other components to the chassis 170. The mounting arrangements 411 are arranged to mount electrical modules 161. Each mounting arrangement 411 may act as the electronics module mount 172. The mounting arrangements 411 are formed by the insulation members 413, acting as electrical insulators. The power source mount is formed by the insulation members 413. In embodiments, the power source mount comprises an adhesive fixing. The provision of these insulation members 413 helps prevent the electrical modules from shorting on the chassis 170.

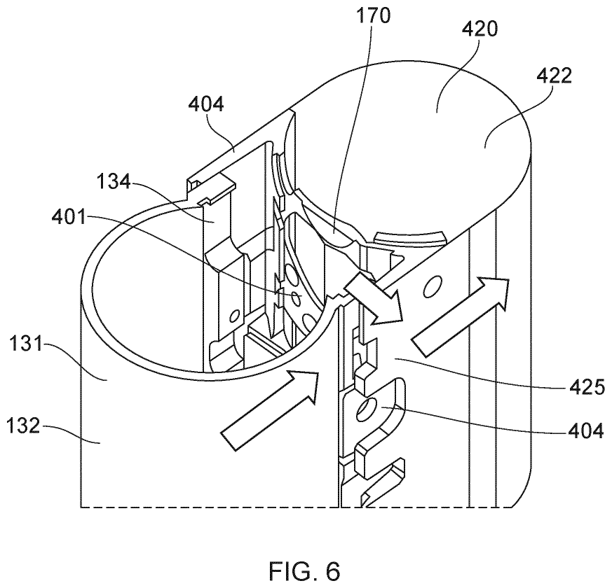

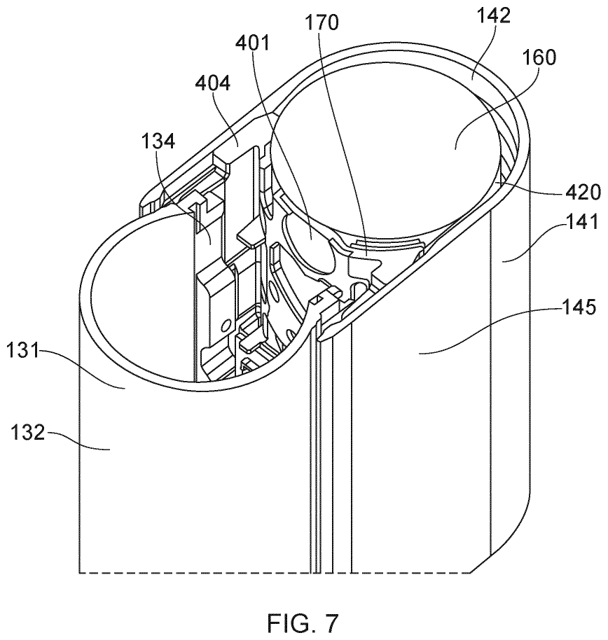

FIG. 6 shows a perspective view of the chassis 170 mounted with the first housing 131, with the power source 160 and second housing 141 omitted for clarity. Meanwhile, FIG. 7 shows the perspective view of FIG. 6, with the power source 160 and second housing 141 in place. A graphite liner 420, acting as a heat dissipation layer, extends from the chassis 170. The graphite liner 420 and the conduction member 406 form the thermal conduction arrangement 401. The graphite liner 420 is surrounded by the second housing 141. The power source 160 is received on the chassis and is enclosed by the graphite liner 420. The graphite liner 420 is received between the power source 160 and an inner side of the second housing 141. In embodiments, the graphite liner 420 is omitted, with the thermal conductive path being provided directly to the second housing 141 from the conduction member 420.

Referring to FIG. 6 and FIG. 7, the first housing 131 is mounted directly to the conduction member 404, and more particularly to the flanged sections 404 of the conduction member 406. In the illustrated embodiment, the first housing 131 is mounted on the inside face of each of the flanged sections 404. The graphite liner 420 is mounted on the outside face of each of the flanged sections 404. Both the first housing 131 and graphite liner 420 have tubular portions, 132 and 422 respectively, and flat portions, 134 and 425 respectively. The flat portions 134, 425 contact the flat flanged sections 404.

As can be seen from FIG. 7, the second housing 141 also has a tubular portion 142, and flat portions 145. The flat portions 145 contact the flat portions 425 of the graphite liner 420.

The thermal conduction arrangement 401 provides a thermal path from the first housing 131 to the second housing 141. The first housing 131 and second housing 141 are in thermal contact between the components to dissipate heat from the first housing to the second housing 141. The thermal contact in embodiments is an indirect thermal contact. According to the present disclosure, a “direct thermal contact” is a contact between two separate elements wherein the contact is free from a further element forming a thermal bridge between them. The two elements are in direct physical contact such that heat can effectively pass between the elements. An “indirect thermal contact” is a contact between two separate elements where a further element is present between the elements such that the elements do not make direct physical contact, but heat may still pass between the elements, via the further element acting as a thermal bridge. A “direct thermal path” is a path through a plurality of elements which are each in direct thermal contact, i.e. a path made up of one or more direct thermal contacts. For example, if element A is in direct thermal contact with element B which is in turn in direct thermal contact with element C, then there is a direct thermal path between element A and element B, even though element A and element C themselves are in indirect thermal contact.

The first housing 131 at least partially houses the heating assembly 221, and as such, the temperature of the first housing 131 increases significantly when the device 100 is in use. By providing direct thermal contact between the flat portions 134 of the first housing 131, and the flanged sections 404 of the conduction member 406, and further between the flanged sections 404, and the flat portions 425 of the graphite liner 420, a direct thermal conduction path between the first housing 131 and the graphite liner 420 is formed. The path of heat, from the first housing 131, to the conduction member 410, to the graphite liner 420, is shown by the arrows in FIG. 6. The flat portions 134, 425 of the first housing 131 and graphite liner 420 respectively correspond to the flat shape of the flanged sections 404 of the conduction member 401, and hence increase the surface area of the respective contact patches which in turn increases the level of thermal transfer.

The result of this direct thermal conduction path is that the heat which is present in the first housing 131 is dissipated, via the conduction member 401 and the graphite liner 420 throughout the structure of the whole device 100, thus lowering the temperature of the first housing 131, and allowing the device to be comfortably held by a user without the need for large amounts of thermal insulation around the first housing 131, which would increase the size and weight of the device 100. Further, the flanged sections 404 are integrally formed with the chassis 170, and so the chassis 170 further draws heat away from the first housing 131.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
a heating assembly arranged to receive at least a portion of an article containing aerosol generating material;
a power supply;
a first housing enclosing at least part of the heating assembly;
a second housing enclosing at least part of the power supply; and
a thermal conduction arrangement in thermal contact between the first housing and the second housing to dissipate heat from the first housing to the second housing.

2. The aerosol provision device of claim 1, wherein the thermal conduction arrangement comprises a conduction member.

3. The aerosol provision device of claim 2, wherein the conduction member defines a direct conduction path between the first housing and the second housing.

4. The aerosol provision device of claim 2, wherein the conduction member is in direct engagement with the first housing.

5. The aerosol provision device of claim 3, wherein the first housing is mounted with the conduction member.

6. The aerosol provision device of claim 2, wherein the thermal conduction arrangement comprises a greater material mass than the first housing.

7. The aerosol provision device of claim 2, comprising a chassis arranged to retain the power supply.

8. The aerosol provision device of claim 7, wherein the chassis comprises the conduction member.

9. The aerosol provision device of claim 8, wherein the chassis is arranged to act as a heat sink.

10. The aerosol provision device of claim 8, wherein the chassis comprises an insulation member.

11. The aerosol provision device of claim 10, wherein the insulation member and the conduction member are integrally formed.

12. The aerosol provision device of claim 10, comprising an electrical module mounted on the insulation member.

13. The aerosol provision device of claim 12, wherein the insulation member electrically isolates the electrical module from the conduction member.

14. The aerosol provision device of claim 2, wherein the heating assembly is retained between the first housing and the conduction member.

15. The aerosol provision device of claim 2, wherein the thermal conduction arrangement comprises a heat dissipation layer between the second housing and the power supply.

16. The aerosol provision device of claim 15, wherein the heat dissipation layer is in thermal contact with the conduction member.

17. The aerosol provision device of claim 16, wherein the heat dissipation layer defines a thermal conductive path between the conduction member and the second housing.

18. The aerosol provision device of claim 15, wherein the heat dissipation layer comprises a graphite liner.

19. An aerosol provision device comprising:
a heating assembly arranged to receive at least a portion of an article containing aerosol generating material;
a power supply;
a first housing enclosing at least part of the heating assembly;
a second housing enclosing at least part of the power supply; and
a heat dissipation arrangement comprising a graphite liner between the power supply and the second housing.

20. An aerosol provision system comprising an aerosol provision device of claim 1, and an article containing aerosol generating material arranged to be at least partially received in the aerosol provision device.
